(19) United States
(12) Patent Application Publication
(10) Pub. No.: US 2006/0049773 A1
(43) Pub. Date: Mar. 9, 2006

(54) Fault protection scheme for CCFL integrated circuits

(76) Inventors: James C. Moyer, San Jose, CA (US); Paul Ueunten, San Jose, CA (US)

Correspondence Address: PERKINS COIE LLP;PATENT-SEA, P.O. BOX 1247, SEATTLE, WA, 98111-1247, US

(21) Appl. No.: 11/210,542

(22) Filed: Aug. 23, 2005

Related U.S. Application Data
(60) Provisional application No. 60/603,979, filed on Aug. 23, 2004.

(51) Int. Cl. H05B 37/02

(52) U.S. Cl. 315/209 R

(57) ABSTRACT

In one embodiment, an apparatus is provided. The apparatus includes a power bridge suitable for coupling to a CCFL (cold cathode fluorescent lamp) load and providing an operating current to the load. The apparatus also includes a replica component coupled to the power bridge to provide a replica current proportional to the operating current. The apparatus further includes a reference component receptacle to produce a reference current in conjunction with an external reference component. The apparatus also includes a comparison component coupled to the replica component and the reference component to compare the replica component to the reference component.

### CROSS-REFERENCE TO RELATED APPLICATION

This application claims priority to U.S. provisional patent application No. 60/603,979, filed on Aug. 23, 2004, which is hereby incorporated herein by reference.

### BACKGROUND

Portable notebook computer systems have become a prevalent consumer item. Laptop users can be seen in airplanes, at cafes, in public parks, and many other places, using their computers. This has proven a great convenience in freeing people from controlled use situations such as a home office or a business office, where a computer may be installed safely and generally not moved.

Due to widespread utilization of laptops, redundant safeguards are desirable to protect users from physical harm. One potential hazard is electrocution by the high voltage supplied to the Cold Cathode Fluorescent Lamp (CCFL) used to provide the backlight to many computers' display systems. While most voltages in a laptop are relatively small in magnitude, the voltage used to power a fluorescent lamp is typically orders of magnitude bigger.

Today most of the CCFL's used in notebook computers are driven by a full bridge power stage that drives a magnetic step up transformer to apply the high voltage required by the CCFL. In this manner, a notebook supply with a typical voltage of 7 to 22V can tightly regulate a 600VRMS voltage to the CCFL in an efficient manner. However, the high voltage applied to the CCFL can easily cause electrocution. For this reason notebook manufacturers implement redundant physical and electrical safety systems to protect consumers from electrocution by the CCFL.

Additionally, most notebook computers are only commercially viable if they are rated acceptable by a third-party laboratory such as Underwriters Labs (UL). UL has various standards and tests which are employed to determine if products are acceptable. One common test for any electrical product are whether the product drives too much current through a human body model load (in this context a resistive load of approximately 2 kohm from any physical point in the circuit to ground). Another common test is whether the product operates safely (or shuts down) when any two physically accessible components are short-circuited (this can be a short between two components or a short to ground). Thus, it may be desirable to provide a robust system for monitoring current in the system driving the CCFL to avoid an overcurrent condition which would fail the UL tests and thus present an electrocution danger.

### SUMMARY

A system, method and apparatus is provided for a fault protection scheme for CCFL integrated circuits. In one embodiment, an apparatus is provided. The apparatus includes a power bridge suitable for coupling to a CCFL (cold cathode fluorescent lamp) load and providing an operating current to the load. The apparatus also includes a replica component coupled to the power bridge to provide a replica current proportional to the operating current. The apparatus further includes a reference component receptacle to produce a reference current in conjunction with an external reference component. The apparatus also includes a comparison component coupled to the replica component and the reference component to compare the replica component to the reference component.

In another embodiment, a method of operating a power supply for a cold cathode fluorescent lamp is provided. The method includes operating the power supply and producing an operating current. Additionally, the method includes producing a reference current with a reference component. Moreover, the method includes producing a replica current proportional to the operating current. Furthermore, the method includes comparing the replica current to the reference current. Also, the method includes signaling a fault if the replica current and the reference current are unequal.

In still another embodiment, a power supply for a cold cathode fluorescent lamp is provided. The power supply includes a first power transistor having a first node, second node and gate node, with the first node coupled to a power supply. The power supply also includes a second power transistor having a first node, second node and gate node. The second power transistor is matched to the first power transistor, and the first node is coupled to a power supply. Additionally, the power supply includes a third power transistor having a first node, second node and gate node. The first node is coupled to the second node of the first power transistor, and the second node is coupled to ground. Moreover, the power supply includes a fourth power transistor having a first node, second node and gate node. The fourth power transistor is matched to the third power transistor. The first node is coupled to the second node of the second power transistor, and the second node is coupled to ground.

The power supply also includes a replica transistor formed proportional to the third and fourth power transistors, having a first node, second node and gate node. The second node is coupled to ground, and the first node is regulated to match the first node of the third and fourth power transistors in alternation. Furthermore, the power supply includes a current mirror. The current mirror is coupled to the first node of the replica transistor. Additionally, the power supply includes a reference terminal, with the reference terminal coupled to the current mirror.

### BRIEF DESCRIPTION OF THE DRAWINGS

The present invention is illustrated in an exemplary manner by the accompanying drawings. The drawings should be understood as exemplary rather than limiting, as the scope of the invention is defined by the claims.

FIG. 1 illustrates an embodiment of a current overload sensing scheme.

FIG. 2 illustrates another embodiment of a current overload sensing scheme.

FIG. 3 illustrates an embodiment of a current overload sensing scheme using an internal replica circuit.

FIG. 4 illustrates an embodiment of loading of a power supply circuit requiring current overload protection.

FIG. 5 illustrates an embodiment of current mirroring and sensing circuitry.

FIG. 6 illustrates an embodiment of monitoring circuitry for a related circuit pin.

FIG. 7 illustrates an embodiment of a process of operation and current overload sensing.

### DETAILED DESCRIPTION

A system, method and apparatus is provided for a fault protection scheme for CCFL integrated circuits. The specific embodiments described in this document represent exemplary instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

In an embodiment, a replica circuit is used to compare current with a reference current through a component chosen proportionally to the necessary output current. The replica current is proportional to an operating current which is supplied to the CCFL (Cold Cathode Fluorescent Lamp). When the operating current and the corresponding replica current runs outside of specified limits, the reference current no longer compares equally with the replica current, and the change is signaled. At that point, the system may be powered down or reduced in power.

In one embodiment, an apparatus is provided. The apparatus includes a power bridge suitable for coupling to a CCFL (cold cathode fluorescent lamp) load and providing an operating current to the load. The apparatus also includes a replica component coupled to the power bridge to provide a replica current proportional to the operating current. The apparatus further includes a reference component receptacle to produce a reference current in conjunction with an external reference component. The apparatus also includes a comparison component coupled to the replica component and the reference component to compare the replica component to the reference component.

In another embodiment, a method of operating a power supply for a cold cathode fluorescent lamp is provided. The method includes operating the power supply and producing an operating current. Additionally, the method includes producing a reference current with a reference component. Moreover, the method includes producing a replica current proportional to the operating current. Furthermore, the method includes comparing the replica current to the reference current. Also, the method includes signaling a fault if the replica current and the reference current are unequal.

In still another embodiment, a power supply for a cold cathode fluorescent lamp is provided. The power supply includes a first power transistor having a first node, second node and gate node, with the first node coupled to a power supply. The power supply also includes a second power transistor having a first node, second node and gate node. The second power transistor is matched to the first power transistor, and the first node is coupled to a power supply. Additionally, the power supply includes a third power transistor having a first node, second node and gate node. The first node is coupled to the second node of the first power transistor, and the second node is coupled to ground. Moreover, the power supply includes a fourth power transistor having a first node, second node and gate node. The fourth power transistor is matched to the third power transistor. The first node is coupled to the second node of the second power transistor, and the second node is coupled to ground.

The power supply also includes a replica transistor formed proportional to the third and fourth power transistors, having a first node, second node and gate node. The second node is coupled to ground, and the first node is regulated to match the first node of the third and fourth power transistors in alternation. Furthermore, the power supply includes a current mirror. The current mirror is coupled to the first node of the replica transistor. Additionally, the power supply includes a reference terminal, with the reference terminal coupled to the current mirror.

Power is delivered to the CCFL through a transformer that steps up the 7 to 22V available from a notebook supply to provide approximately the 600 Vrms needed to drive the CCFL. The primary side of the transformer is driven by a driver circuit whose supply is the notebook supply, while the secondary side drives the CCFL. The driver circuit principally uses a bridge in one embodiment which is described and illustrated in this document.

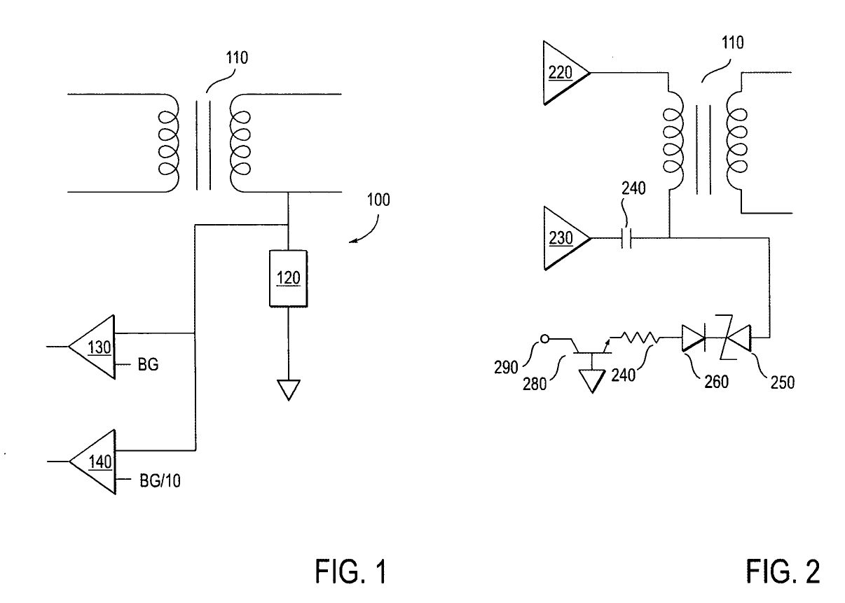

Typically a protection circuit monitors the power delivered to the CCFL load by placing a resistor in series with the secondary winding to ground. In this manner, if a person comes in contact with the CCFLs' high voltage terminal thus providing a path to ground, the amount of current supplied by the transformer can easily be monitored by the voltage developed across the resistor. In an older design, if the voltage across the resistor exceeds 1.2 Volts the IC will reduce the power delivered in order to maintain the 1.2V peak voltage across the resistor thus providing an upper limit to the current that can be supplied by the transformer. This design is illustrated in FIG. 1.

Underwriter's Laboratory (UL) has various industry standards applying to CCFL protection. While the circuit used in FIG. 1 will protect against a single point failure, that is, touching the high voltage terminal of the transformer, it does not protect if there is a short from the resistor in series with the secondary winding of the transformer to ground. Such a short would disable the protection circuitry.

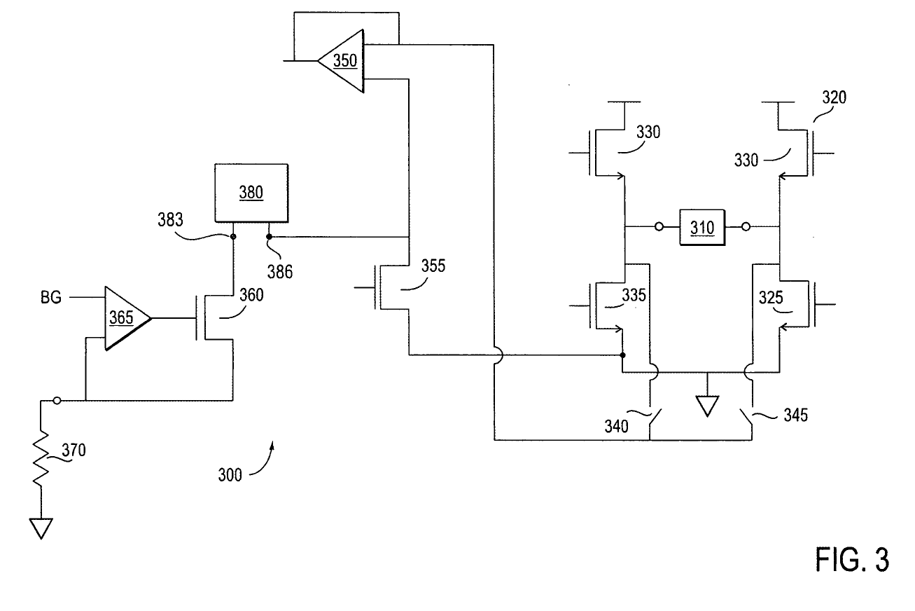

A different control method is provided in FIG. 3-5. For one embodiment, a part is provided with a pin 9 which is grounded. Here the voltage on SetI pin 8 is set regulated to approximately 1.2V (the bandgap voltage). A resistor is placed from this pin to ground. The current from pin 8 through the resistor is proportional to the maximum current delivered to the primary winding of the transformer and therefore to the secondary of the transformer.

The parts circuitry is configured such that if there is a short to ground, the part will not start. Note that pin 9, the adjacent pin to SetI pin 8, is ground. The other adjacent pin is FT pin 7. A short here also will not disable the current limit function of the SetI pin. This will pass the UL fault testing and regulate current acceptably.

FIG. 1 illustrates an embodiment of a current overload sensing scheme. Illustrated is a system 100 including a transformer with a current sensor. Transformer 110 may be coupled to a bridge which drives the transformer, thus producing a desired output voltage. Coupled between one of the windings (the output winding) and ground is a load 120, which is typically a resistor. For ease of reference, the step-up winding of the transformer is referred to as the output winding and the step-down winding is referred to as the input winding for the circuits of this document. Load 120 provides a reference voltage at the point where it is coupled to the winding. This reference voltage is provided to two comparators 130 and 140.

Comparator 130 receives a bandgap voltage (approximately 1.2 V) as input and compares the reference voltage to the bandgap voltage. Comparator 140 similarly receives the bandgap voltage divided by 10 as input, and thus provides a comparison between the bandgap voltage divided by 10 and the reference voltage. When the circuit is operating properly, the output of comparator 140 will typically be some form of square wave (potentially a sum of two square waves). Thus, detecting proper operation may be difficult.

Instead of using a test of voltage at the output of the transformer, voltage at the input side of the transformer may be measured. FIG. 2 illustrates another embodiment of a current overload sensing scheme. Transformer 110 is again illustrated. Buffers 220 and 230 represent the bridge which drives transformer 110 from inside a CCFL regulator integrated circuit. Capacitor 240 is provided in series between buffer 230 and a terminal of transformer 110. Also coupled to the terminal of transformer 110 is a series of components—Zener diode 250, diode 260, resistor 270 and common base transistor 280, which all lead to terminal 290. Terminal 290 can be measured by a comparator to determine if the conditions at the terminal of the transformer are reasonable. However, each of the components illustrated are typically discrete components on a circuit board, which may be shorted in a UL test or by human contact, thus resulting in a failure of the testing circuitry. Thus, this testing scheme introduces more complexity without providing a robust test of the device.

What may then be useful is a testing scheme which is robust—relatively easy to measure and relatively unlikely to result in failures due to UL-style shorting or contact. FIG. 3 illustrates an embodiment of a current overload sensing scheme using an internal replica circuit. Circuit 300 is a bridge circuit which drives a load 310 and is monitored by a replica circuit and monitoring components.

Transistors 320, 325, 330 and 335 provide a bridge which supplies power to load 310. Each of transistors 320, 325, 330 and 335 are typically power MOSFETs, sourcing and sinking high currents and requiring large real estate layouts on an integrated circuit. The bridge operates by alternately supplying current through the two branches (320 and 325, 330 and 335 respectively). Thus, transistors 320 and 325 may correspond to buffer 220 and transistors 330 and 335 may correspond to buffer 230, for example. Also provided is replica MOSFET 355, which replicates transistors 325 and 335, without requiring the same large real estate (or handling the same current). Transistors 325, 335 and 355 are all biased at the same voltage levels (with a common ground node). Switches 340 and 345 are alternatively closed, effectively linking the nodes to an input of operational amplifier (op-amp) 350. As illustrated, switches 340 and 345 are used to couple the non-conducting branch of the bridge to the op-amp 350.

Operational amplifier thereby maintains the node of transistor 355 in the same state as the corresponding node of transistors 325 and 335. This node is also coupled to terminal 386 of current mirror 380. Terminal 383 of current mirror 380 is coupled to transistor 360, which is coupled to external resistor 370 and op-amp 365. Op-amp 365 operates to keep its inputs at the same voltage, thereby keeping the voltage drop across resistor 370 at the bandgap voltage. Resistor 370 is chosen by the designer of a system to have a value appropriate for a current responsive to the bandgap voltage which is proportional to the current of the bridge. The proportion is specified with the integrated circuit, allowing a designer to choose the resistor according to current/power needs. Thus, for the device described previously, resistor 370 is an external resistor from pin 8 (Set I) to ground, and the terminal of resistor 370 is the pin Set I.

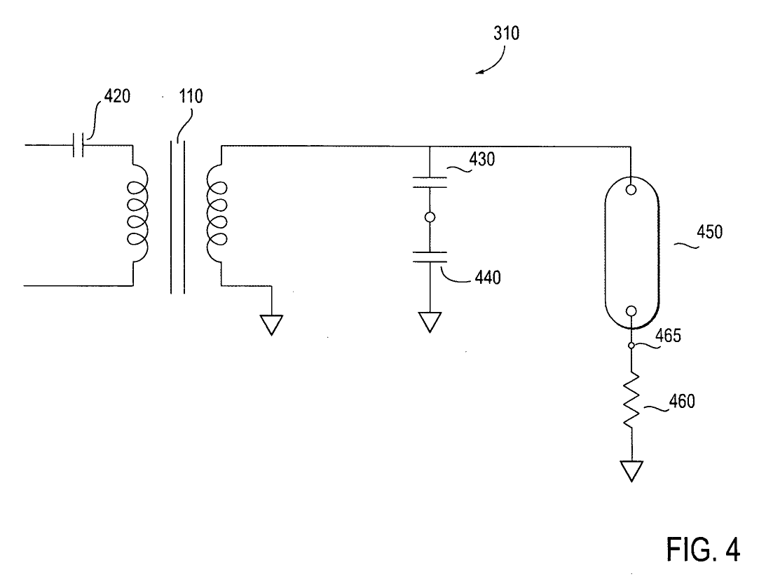

The load which needs to be monitored is typically a fluorescent lamp. FIG. 4 illustrates an embodiment of loading of a power supply circuit requiring current overload protection. Transformer 110 has a series capacitor 420 coupled thereto on the input winding. Coupled in parallel with the output winding are capacitors 430 and 440, and a series connection of lamp 450 and resistor 460. Between lamp 450 and resistor 460 is node 465. If node 465 is shorted to ground, or contacted by a human (as simulated by the human body model), the current through the load should still be regulated.

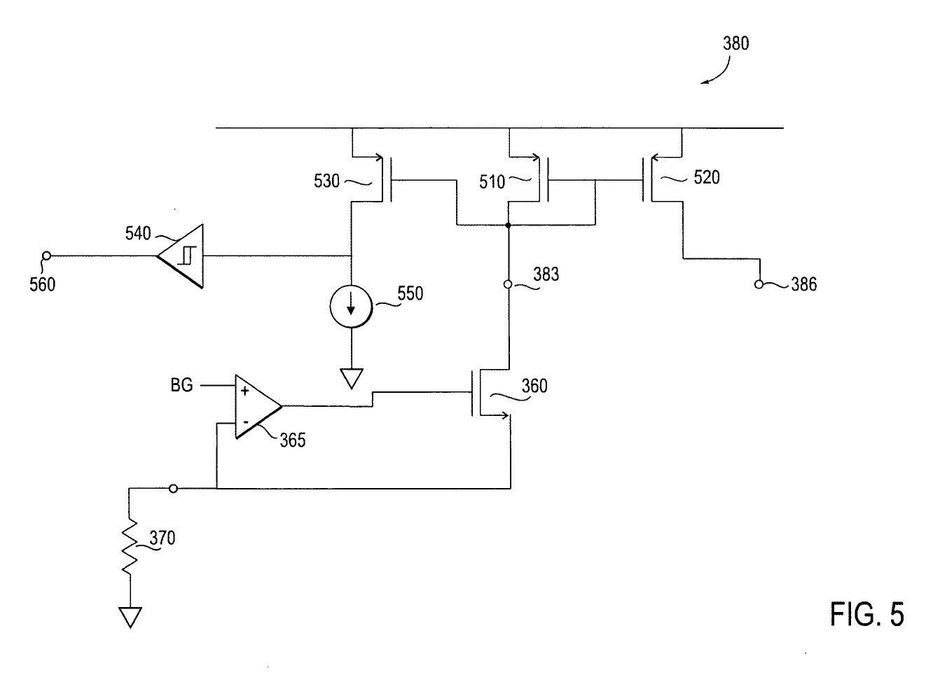

The final piece of the regulating circuitry is the current mirror and sensing circuitry. FIG. 5 illustrates an embodiment of current mirroring and sensing circuitry. Current mirror 380 uses transistors 510, 520 and 530 to mirror the same current through each transistor. Thus, the current at nodes 383 and 386 is the same, and the current through current source 550 is the same current as well. Should the current at node 380 (the node of replica transistor 355) change, a voltage change will occur at the input to Schmitt-triggered buffer 540, and it can be sensed at node 560. Thus, node 560 may provide an active low signal indicating that the bridge should be powered down or ratcheted back based on other system requirements. This active low signal may be used, for example, to change the biasing (or cutoff) transistors 320 and 330 of FIG. 3, thereby reducing or eliminating power supply.

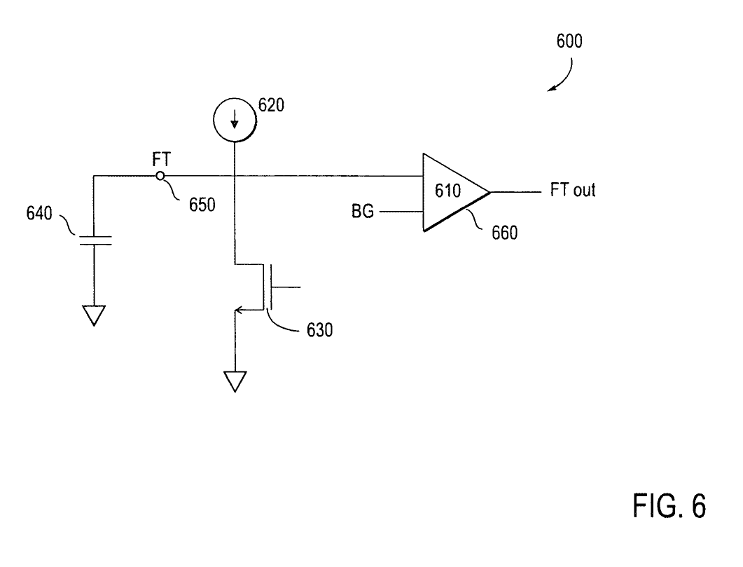

On some devices, the pin next to the pin where resistor 370 is connected is the FT pin. FIG. 6 illustrates an embodiment of monitoring circuitry for a related circuit pin. As illustrated, the FT pin (node 650) has a capacitor coupled thereto, with the capacitor also coupled to ground. Within the integrated circuit, a current source 620 and transistor 630 are both coupled to the input to op-amp 610. Op-amp 610 also has the bandgap voltage coupled to its other input. The output of op-amp 610 is provided as FT_OUT signal 660.

If FT node 650 is shorted to ground, then the node will not rise above the bandgap voltage. As op-amp 610 compares the bandgap voltage to the node 650, output 660 will remain low (inactive). Under normal operation, node 650 will rise with a time delay, causing output 660 (FT_OUT) to also transition to a logic high.

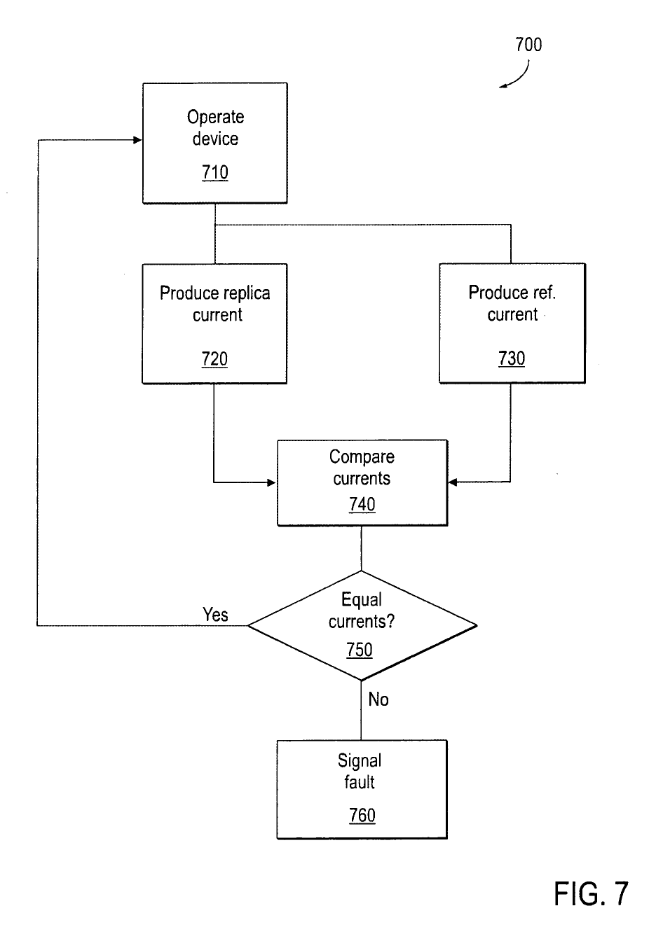

The process of the regulation of current may be understood with reference to a flow diagram. FIG. 7 illustrates an embodiment of a process of operation and current overload sensing. Process 700 includes operating the device, producing reference and replica currents, comparing the currents, and either signaling a fault or continuing operation. Process 700 and other methods of this document are composed of modules which may be rearranged into parallel or serial configurations, and may be subdivided or combined. The method may include additional or different modules, and the modules may be reorganized to achieve the same result, too.

The device operates at module 710. This produces an operating current which powers the CCFL load. A replica current (such as that of transistor 355 of FIG. 3) is produced at module 720. Likewise, a reference current (such as that of resistor 370) is produced at module 730. The currents are compared at module 740. If the currents are equal, at module 750, the process returns to module 710. If the currents are not equal, a fault signal is produced at module 760.

Features and aspects of various embodiments may be integrated into other embodiments, and embodiments illustrated in this document may be implemented without all of the features or aspects illustrated or described. One skilled in the art will appreciate that although specific examples and embodiments of the system and methods have been described for purposes of illustration, various modifications can be made without deviating from the spirit and scope of the present invention. For example, embodiments of the present invention may be applied to many different types of databases, systems and application programs. Moreover, features of one embodiment may be incorporated into other embodiments, even where those features are not described together in a single embodiment within the present document. Accordingly, the invention is described by the appended claims.

What is claimed is:

1. An apparatus, comprising:
a power bridge suitable for coupling to a CCFL (cold cathode fluorescent lamp) load and providing an operating current to the load;
a replica component coupled to the power bridge to provide a replica current proportional to the operating current;
a reference component receptacle to produce a reference current in conjunction with an external reference component;
and
a comparison component coupled to the replica component and the reference component to compare the replica component to the reference component.

2. The apparatus of claim 1, wherein:
the replica component is coupled through an operational amplifier to the power bridge.

3. The apparatus of claim 1, wherein:
the comparison component is a current mirror and a buffer coupled to the current mirror.

4. The apparatus of claim 1, wherein:
the reference component receptacle is coupled to an external reference component chosen in proportion to an expected output level of the power bridge.

5. The apparatus of claim 1, further comprising:
a bandgap voltage regulator coupled to the reference component receptacle.

6. The apparatus of claim 5, wherein:
the bandgap voltage regulator includes a transistor coupled between the comparison component and the reference component receptacle and an operational amplifier having an output coupled to the transistor, a first input coupled to the reference component receptacle and a second input coupled to a bandgap voltage reference.

7. The apparatus of claim 1, wherein:
The power bridge is a set of matched power MOSFETs.

8. The apparatus of claim 7, wherein:
the replica component is a MOSFET scaled in proportion to power MOSFETs of the power bridge.

9. The apparatus of claim 1, further comprising:
a bandgap voltage regulator coupled to the reference component receptacle,
the bandgap voltage regulator including a first MOSFET coupled between the comparison component and the reference component receptacle and a first operational amplifier having an output coupled to the transistor, a first input coupled to the reference component receptacle and a second input coupled to a bandgap voltage reference.

10. The apparatus of claim 9, wherein:
the comparison component is a current mirror and a buffer coupled to the current mirror.

11. The apparatus of claim 10, wherein:
the power bridge is a set of matched power MOSFETs;
and
the replica component is a second MOSFET scaled in proportion to power MOSFETs of the power bridge.

12. A method of operating a power supply for a cold cathode fluorescent lamp, the method comprising:
operating the power supply and producing an operating current;
producing a reference current with a reference component;
producing a replica current proportional to the operating current;
comparing the replica current to the reference current;
and
signaling a fault if the replica current and the reference current are unequal.

13. The method of claim 12, wherein:
the reference component is a resistor coupled to the power supply.

14. The method of claim 12, further comprising:
buffering a fault pin of the power supply by comparing the fault pin to a bandgap voltage.

15. A power supply for a cold cathode fluorescent lamp, comprising:
A first power transistor having a first node, second node and gate node, the first node coupled to a power supply;
A second power transistor having a first node, second node and gate node, the second power transistor matched to the first power transistor, the first node coupled to a power supply;
A third power transistor having a first node, second node and gate node, the first node coupled to the second node of the first power transistor, the second node coupled to ground;
A fourth power transistor having a first node, second node and gate node, the fourth power transistor matched to the third power transistor, the first node coupled to the second node of the second power transistor, the second node coupled to ground;
A replica transistor formed proportional to the third and fourth power transistors, having a first node, second node and gate node, the second node coupled to ground, the first node regulated to match the first node of the third and fourth power transistors in alternation;
A current mirror, the current mirror coupled to the first node of the replica transistor;
And
A reference terminal, the reference terminal coupled to the current mirror.

16. The power supply of claim 15, further comprising:
an operational amplifier having a first input and a second input, the first input coupled to the first node of the replica transistor, the second input alternatingly coupled to the first node of the third power transistor and the first node of the fourth power transistor.

17. The power supply of claim 15, further comprising:
a Schmitt-triggered buffer coupled to the current mirror.

18. The power supply of claim 15, further comprising:
a transistor having a first node, second node and gate node, the first node coupled to the current mirror, the second node coupled to the reference terminal;
and
an operational amplifier, having a first input, second input and output, the first input coupled to a bandgap voltage reference, the second input coupled to the reference terminal, the output coupled to the gate node of the transistor.

19. The power supply of claim 15, further comprising:
an operational amplifier, having a first input, second input and output, the second input coupled to the first node of the replica transistor, the output coupled to the first input;
a first switch, the first switch coupled between the first input of the operational amplifier and the first node of the third power transistor;
and
a second switch, the second switch coupled between the first input of the operational amplifier and the first node of the fourth power transistor.

20. The power supply of claim 15, further comprising:
a Schmitt-triggered buffer coupled to the current mirror;
a reference transistor having a first node, second node and gate node, the first node coupled to the current mirror, the second node coupled to the reference terminal;
a first operational amplifier, having a first input, second input and output, the first input coupled to a bandgap voltage reference, the second input coupled to the reference terminal, the output coupled to the gate node of the reference transistor;
a second operational amplifier, having a first input, second input and output, the second input coupled to the first node of the replica transistor, the output coupled to the first input;
a first switch, the first switch coupled between the first input of the second operational amplifier and the first node of the third power transistor;
and
a second switch, the second switch coupled between the first input of the second operational amplifier and the first node of the fourth power transistor.
